(19) United States
(12) Patent Application Publication
(10) Pub. No.: US 2019/0012030 A1
(43) Pub. Date: Jan. 10, 2019

(54) INPUT APPARATUS AND INPUT SYSTEM

(71) Applicant: DENSO TEN Limited, Kobe-shi (JP)

(72) Inventors: Hironobu MOROFUJI, Kobe-shi (JP); Yutaka MATSUNAMI, Kobe-shi (JP)

(73) Assignee: DENSO TEN Limited, Kobe-shi (JP)

(21) Appl. No.: 15/986,241

(22) Filed: May 22, 2018

(30) Foreign Application Priority Data
Jul. 5, 2017 (JP) 2017-131961

(51) Int. Cl. G06F 3/041; G08B 6/00

(52) U.S. Cl. CPC G06F 3/0412; G02F 1/13338; G08B 6/00

(57) ABSTRACT

An input apparatus includes an operation panel, a vibrator, and a holding part. The operation panel includes an operation surface. The vibrator is attached to the operation panel, and vibrates the operation panel in a plurality of modes having different vibration frequencies. The holding part holds the operation panel. The holding part includes a first holding part, and a second holding part that has a higher hardness than the first holding part, and is arranged to be laminated on the first holding part.

### CROSS-REFERENCE TO RELATED APPLICATION

This application is based upon and claims the benefit of priority of the prior Japanese Patent Application No. 2017-131961, filed on Jul. 5, 2017, the entire contents of which are incorporated herein by reference.

### FIELD

The embodiments discussed herein are directed to an input apparatus and an input system.

### BACKGROUND

Conventionally, there has been known an input apparatus that causes a user to recognize reception of his/her input operation by providing a tactile sense to the user. This input apparatus generates vibration in accordance with, for example, a pressing force of the user against an operation surface so as to cause the user to recognize the reception of his/her input operation (see, e.g., Japanese Laid-open Patent Publication No. 2013-235614).

However, the above-mentioned input apparatus has room for improvement in effectively generating vibration in the operation panel that has the operation surface. In other words, the operation panel is held by a holding part. The input apparatus vibrates, in some cases, the operation panel in a plurality of modes having different vibration frequencies such as a high-frequency vibration and a low-frequency vibration.

The above-mentioned vibration is easily generated in the operation panel when the rigidity of the operation panel and/or the holding part is higher as a vibration frequency is higher. However, for example, when the hardness of the holding part is comparatively high in order to heighten the rigidity of the holding part, a high-frequency vibration is easily generated in the operation panel; on the other hand, generating a low-frequency vibration becomes difficult. On the contrary, for example, when the hardness of the holding part is comparatively low in order to lower the rigidity of the holding part, the low-frequency vibration is easily generated in the operation panel; on the other hand, generating the high-frequency vibration becomes difficult. As described above, the conventional technology has room for improvement in effectively generating, in the operation panel, vibration having a plurality of modes having different vibration frequencies.

### SUMMARY

An input apparatus according to an aspect of an embodiment includes an operation panel, a vibrator, and a holding part. The operation panel includes an operation surface. The vibrator is attached to the operation panel, and vibrates the operation panel in a plurality of modes having different vibration frequencies. The holding part holds the operation panel. The holding part includes a first holding part, and a second holding part that has a higher hardness than the first holding part, and is ranged to be laminated on the first holding part.

### BRIEF DESCRIPTION OF DRAWINGS

A more complete appreciation of the invention and many of the attendant advantages thereof will be readily obtained as the same becomes better understood by reference to the following detailed description when considered in connection with the accompanying drawings, wherein:

FIG. 1 is a side cross-sectional view illustrating an input apparatus according to a first embodiment;

FIG. 2 is a diagram illustrating a mounted example of an electronic-device system according to the first embodiment;

FIG. 3 is a diagram illustrating a configuration example of the electronic-device system according to the first embodiment;

FIG. 4 is a plan view illustrating an input system according to the first embodiment;

FIG. 5 is a cross-sectional view of FIG. 4 taken along a line V-V;

FIG. 6 is a cross-sectional view of FIG. 4 taken along a line VI-VI;

FIG. 7 is a diagram illustrating a relation between the input system and a display of the electronic-device system;

FIG. 8 is a side cross-sectional view illustrating an input apparatus according to a modification; and

FIG. 9 is a side cross-sectional view illustrating an input apparatus according to a second embodiment.

### DESCRIPTION OF EMBODIMENTS

### First Embodiment

1. Outline of Input Apparatus

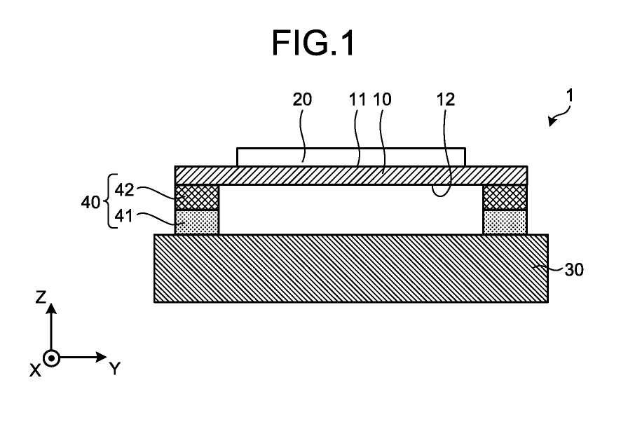

Hereinafter, an outline of an input apparatus according to a first embodiment will be first explained with reference to FIG. 1. FIG. 1 is a side cross-sectional view illustrating the input apparatus according to the first embodiment.

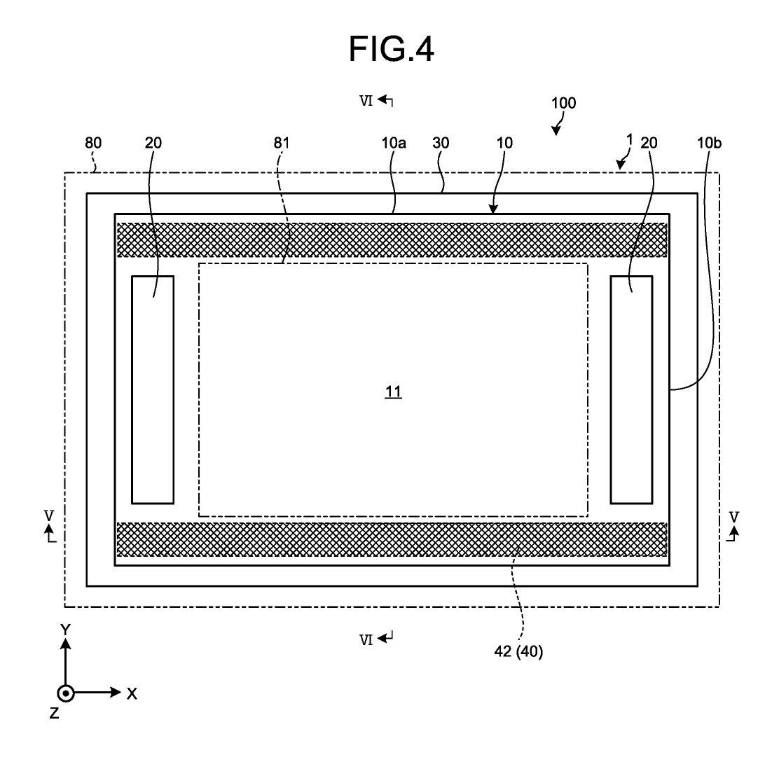

FIGS. 4, and the following are schematic diagrams. Therefore, a size and/or a shape of each configuration element illustrated in FIG. 1 and the like is not always precise. For convenience of comprehension, there exists in the accompanying drawings a case where each configuration element is indicated exaggeratedly. In FIG. 1, a three-dimensional orthogonal coordinate system including an X-axis, a Y-axis, and a Z-axis is depicted. This three-dimensional orthogonal coordinate system may be depicted in another drawing of the accompanying drawings.

As illustrated in FIG. 1, an input apparatus 1 includes an operation panel 10, vibrators 20, a supporting panel 30, and holding parts 40. The input apparatus 1 is controlled by a controller (not illustrated), and is able to be used as a touch pad having a vibration function that vibrates an operation surface 11 of the operation panel 10, for example. As described later, the input apparatus 1 and the controller may be combined with a display, such as a liquid crystal display, to be used as a touch panel having a vibration function.

The operation panel 10 is a member that is formed in a plate-like shape, and has the operation surface 11 substantially in the center thereof. The operation panel 10 has a function for detecting a contact position of a user on operation surface 11. For example, the operation panel 10 includes an electrostatic-capacity touch censor (not illustrated), and is able to detect a touch position of the user on the operation surface 11 by using this touch censor. When the operation panel 10 does not have a function for detecting a touch position, the supporting panel 30 may have the function for detecting the touch position, or a configuration for detecting the touch position may be additionally provided. The user touches the operation surface 11 with his/her finger etc., or the user touches the operation surface 11 with a stylus pen etc., so as to perform his/her touch on the operation surface 11, for example.

Each of the vibrators 20 is a vibration element such as a piezoelectric element (piezo element). The number of the vibrators 20 is two or more (herein, the number of vibrators 20 is two, and one of the two does not appear in FIG. 1). In FIG. 1 the two vibrators 20 are exemplified; however, not limited thereto, the number of two vibrators 20 may be one or equal to or more than three.

The vibrators 20 are fixed and attached to, for example, the operation surface 11 of the operation panel 10 by using adhesive agent etc. The vibrators 20 vibrate the operation panel 10. For example, the vibrators 20 are controlled by the controller, and are capable of vibrating the operation panel 10 in a plurality of modes having different vibration frequencies.

Specifically, the vibrators 20 vibrate the operation panel 10 at a high frequency within an ultrasonic band, or vibrate the operation panel 10 at a low frequency that is lower than the ultrasonic band in a state where a finger of the user is in contact with the operation surface 11. Thus, a smooth haptic sense or a vibrating haptic sense is able to be provided to the user's finger that is on the operation surface 11; this point will be mentioned later with reference to FIG. 3.

The supporting panel 30 supports the operation panel 10. Specifically, the supporting panel 30 is a member that is formed in a plate-like shape. The supporting panel 30 is arranged so as to face a reverse face 12 that is reverse to the operation surface 11 of the operation panel 10 so as to support the operation panel 10 via the holding parts 40.

Each of the holding parts 40 is arranged between the operation panel 10 and the supporting panel 30, for example, and holds the operation panel 10 from the reverse face 12 side.

Meanwhile, as described above, the input apparatus 1 according to the present embodiment vibrates the operation panel 10 in the plurality of modes having different vibration frequencies, such as the high-frequency vibration and the low-frequency vibration.

When the input apparatus 1 vibrates the operation panel 10 at a high frequency within the ultrasonic band, a standing wave is generated in the operation panel 10. This standing wave is generated in the operation panel 10 more easily as the rigidity of the holding parts 40 is higher, which is caused by increasing the hardness of the holding parts 40, for example. Specifically, for example, when the rigidity of the holding parts 40 is low, which is caused by lowering the hardness of the holding parts 40, vibration of the vibrators 20 is absorbed by the holding parts 40, and thus there exists possibility that the generation of the standing wave performed by the operation panel 10 is inhibited as a result. Thus, when the input apparatus 1 vibrates the operation panel 10 at a high frequency, it is preferable that the hardness of the holding parts 40 is high.

However, when the rigidity of the holding parts 40 is high, which is caused by increasing the hardness of the holding parts 40, the operation panel 10 becomes hard to be displaced with respect to the supporting panel 30, in other words, the operation panel 10 becomes hard to be vibrated. Thus, when the input apparatus 1 is going to vibrate the operation panel 10 at a low frequency, a low-frequency vibration is hard to be generated in the operation panel 10. In other words, when the input apparatus 1 vibrates the operation panel 10 at a low frequency, it is preferable that the hardness of the holding parts 40 is low so that the operation panel 10 becomes easy to be vibrated with respect to the supporting panel 30. As described above, a preferable hardness of the holding parts 40 differs depending on the high-frequency vibration and the low-frequency vibration.

Therefore, in the present embodiment, each of the holding parts 40 is configured to include a plurality of holding parts (two holding parts in the present embodiment) having different hardness. Thus, vibrations in a plurality of modes having different vibration frequencies are able to be efficiently generated in the operation panel 10.

Specifically, each of the holding parts 40 according to the present embodiment includes a first holding part 41 and a second holding part 42. The first holding part 41 and the second holding part 42 are arranged so that they are laminated between the operation panel 10 and the supporting panel 30. For example, each of the first holding parts 41 is arranged on the supporting panel 30. Each of the second holding parts 42 is arranged to be laminated between the corresponding first holding part 41 and the operation panel 10.

The first holding part 41 is a holding pa having a comparatively low hardness. As the first holding part 41, materials such as an urethane foam substrate and a polyolefin foam substrate are able to be used. The thickness of the first holding part 41 is approximately 0.4 mm, for example. The second holding part 42 is a holding part having a comparatively high hardness, specifically, is a holding part having a higher hardness than the first holding part 41. As the second holding part 42, glass or resin including glass is able to be used, for example. For example, as the second holding part 42, materials such as a soda-lime glass, a borosilicate glass, a tempered glass, a glass epoxy resin, and a polycarbonate are able to be used. The thickness of the second holding part 42 is approximately 0.3 mm, for example. In the above description, the materials of the first and second holding parts 41 and 42 are specifically exemplified; however, they are merely examples, and not limited thereto. With regard to an arrangement order of the first and second holding parts 41 and 42, it is sufficient that a material having a higher hardness (for example, higher Young's modulus) arranged close to a vibration surface (for example, operation panel 10).

As described above, in the present embodiment, the second holding parts 42 having a comparatively high hardness are configured to hold the operation panel 10. Therefore, the operation panel 10 is stiffly held by the second holding parts 42, and thus a standing wave caused by vibration of the vibrators 20 is easily generated and the vibration generated in the operation panel 10 is not easily absorbed by the second holding parts 42. Thus, when the vibrators 20 are vibrated at a high frequency, the input apparatus 1 is able to efficiently generate a standing wave in the operation panel 10 in accordance with the vibration of the vibrators 20.

Moreover in the present embodiment, the first holding parts 41 having a comparatively low hardness are configured to hold the operation panel 10 and the second holding parts 42. Thus, when the vibrators 20 are vibrated at a low frequency, for example, both of the operation panel 10 and the second holding parts 42 are largely vibrated with respect to the supporting panel 30 in accordance with the vibration of the vibrators 20, so that the input apparatus 1 is able to efficiently generate a low-frequency vibration in the operation panel 10.

As described above, in the present embodiment, by using the first and second holding parts 41 and 42 having different hardness, it is possible to efficiently generate, in the operation panel 10, vibration in a plurality of modes having different vibration frequencies such as a high-frequency vibration and a low-frequency vibration.

2. Mounted Example of Electronic-Device System

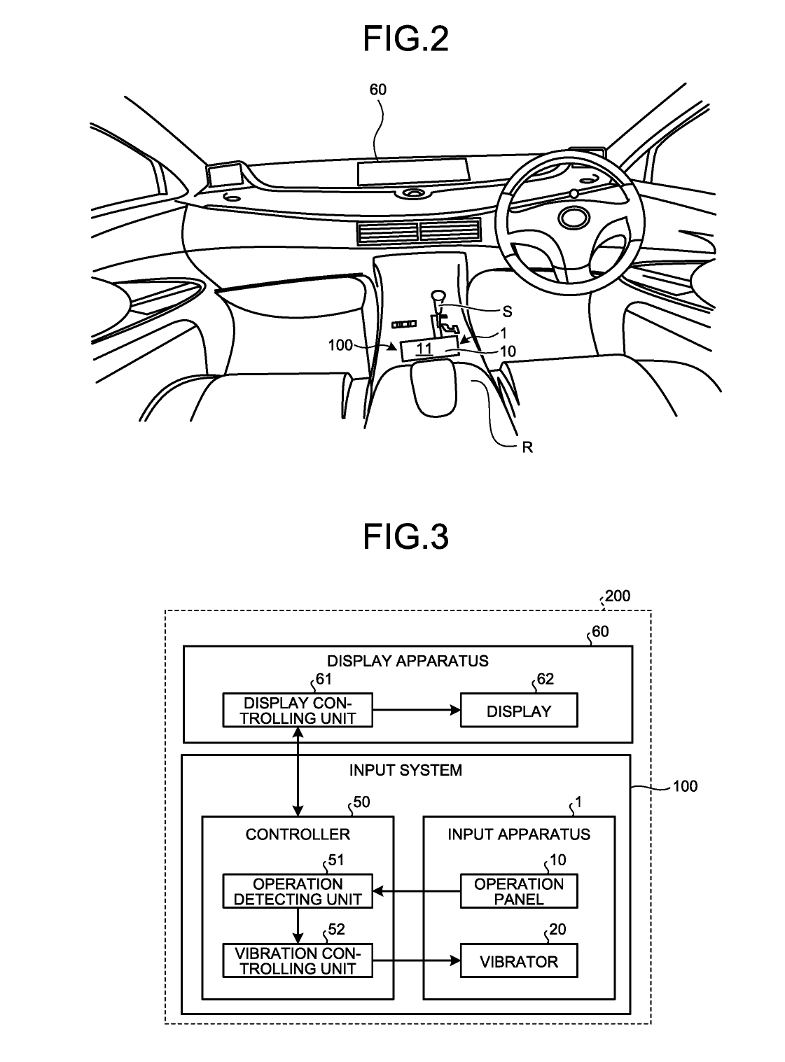

FIG. 2 is a diagram illustrating a mounted example of an electronic-device system 200 including an input system 100 that is constituted of the input apparatus 1 according to the first embodiment. As illustrated in FIG. 2, the electronic-device system 200 according to the present embodiment is mounted on a vehicle as one example.

The electronic-device system 200 includes the input system 100 and a display apparatus 60. The input system 100 is connected to on-vehicle devices such as the display apparatus 60 and a speaker via network communication so as to function as input devices of the on-vehicle devices. The input system 100 includes the input apparatus 1, and the input apparatus 1 is able to be used as a touch pad as described above.

The operation surface 11 of the operation panel 10 is arranged at a position that is easily accessed by a driver, such as a neighborhood of a shifter S on a center console. In the example illustrated in FIG. 2, the operation surface 11 is arranged between an armrest R and the shifter S. Therefore, the user is able to operate the operation surface 11 with his/her arm on the armrest R. Thus, the user is able to easily operate the input system 100 without changing his/her driving posture.

The on-vehicle devices are various devices such as the display apparatus 60 that displays a predetermined image, a speaker that outputs a predetermined sound, an air conditioner, and a car navigation system. Therefore, the user is able to operate these various devices by operating the input system 100.

When receiving an input operation of the user, the above-mentioned input system 100 generates a high-frequency vibration or a low-frequency vibration in the operation panel 10 in accordance with this input operation, so that it is possible to cause the user to recognize reception of his/her input operation.

3. Details of Electronic-Device System

Next, the electronic-device system 200 according to the first embodiment will be explained with reference to FIG. 3. FIG. 3 is a diagram illustrating a configuration example of the electronic-device system 200 according to the first embodiment. In FIG. 3, configuration elements needed for explaining features of the present embodiment are depicted by using functional blocks, and depiction of common configuration element(s) is omitted.

In other words, the configuration elements illustrated in FIG. 3 are functionally conceptual, and thus they are not to be physically configured as illustrated in the drawings. For example, specific forms of distribution and integration of the configuration elements are not limited to those illustrated in the drawings, and all or some of the devices can be configured by separating or integrating the apparatus functionally or physically in any unit, according to various types of loads, the status of use, etc.

As illustrated in FIG. 3, the electronic-device system 200 includes the input system 100 and the display apparatus 60. The input system 100 includes the input apparatus 1 and a controller 50. The input apparatus 1 receives an input operation of the user. The input apparatus 1 includes the above-mentioned operation panel 10 and the vibrators 20. When receiving an input from the user via the operation surface 11, the operation panel 10 detects a contact (touch) position between the user and the operation surface 11, and outputs to the controller 50 a signal that includes information (for example, coordinate information) according to the detected touch position.

The controller 50 controls the vibrators 20 in accordance with the touch position detected by the operation panel 10 of the input apparatus 1. The controller 50 is a microcomputer including a Central Processing Unit (CPU) and a storage among other things.

The controller 50 includes an operation detecting unit 51 and a vibration controlling unit 52. The operation detecting unit 51 detects the input operation performed by the user on the operation surface 11, on the basis of the information on the touch position that is output from the operation panel 10.

For example, in a case where the electronic-device system 200 is used as a car navigation system, when the information on the touch position that is output from the operation panel 10 indicates a position corresponding to a destination setting button of the operation surface 11, the operation detecting unit 51 detects that the input operation of the user is an input operation for setting a destination.

When detecting the input operation performed by the user on the operation surface 11, the operation detecting unit 51 outputs a signal indicating the detected input operation to the vibration controlling unit 52 and the display apparatus 60.

The vibration controlling unit 52 outputs a voltage signal to the vibrators 20 on the basis of the signal that is output from the operation detecting unit 51, namely, the signal indicating the input operation of the user, so as to control the vibrators 20. In other words, the vibration controlling unit 52 controls the vibrators 20 on the basis of the input operation performed on the operation surface 11.

Specifically, the vibration controlling unit 52 is able to control the vibrators 20 on the basis of the input operation performed on the operation surface 11 so as to vibrate the operation panel 10 in a plurality of modes having different vibration frequencies. More specifically, the vibration controlling unit 52 is able to control the vibrators 20 on the basis of the input operation performed on the operation surface 11 so as to switch between a mode for generating in the operation panel 10 a vibration having a frequency within the ultrasonic band and a mode for generating in the operation panel 10 a vibration within a frequency band lower than the ultrasonic band.

The frequency (high frequency) of the above-mentioned ultrasonic band is 20 to 40 kHz, for example, and the frequency (low frequency) lower than the ultrasonic band is equal to or less than 200 Hz, for example; however, not limited thereto. The mode for generating the vibration having the high frequency within the ultrasonic band is one example of a first vibration mode. The mode for generating the vibration having the low frequency is one example of a second vibration mode.

When the vibration controlling unit 52 controls the vibrators 20 and the operation panel 10 is vibrated at a high frequency within the ultrasonic band, a standing wave is generated in the operation panel 10, so that it is possible to reduce, by using the squeeze effect, the frictional force against the user on the operation surface 11.

Here, the squeeze effect indicates a phenomenon that, when the vibrators 20 vibrate the operation surface 11 at a high frequency to generate therein a standing wave, an air layer is formed between a finger of the user and the operation surface 11 by the pressure fluctuation that is cause by the vibration, and the frictional resistance between the finger of the user and the operation surface becomes relatively low compared with a case without the vibration.

As described above, the frictional force on the operation surface 11 of the operation panel 10 is reduced, it is possible to provide a smooth haptic sense to the user as if a finger of the user was drawn in a slide direction of a slide operation of the user moving his/her finger on the operation surface 11 of the operation panel 10, for example.

When the vibration controlling unit 52 controls the vibrators 20 so as to vibrate the operation panel 10 at frequency in a state where a finger of the user is in contact with the operation surface 11, vibration of the vibrators 20 is transmitted to the user's finger via the operation panel 10 to be able to provide vibrating haptic sense to the user's finger.

The display apparatus 60 includes a display controlling unit 61 and a display 62. The display controlling unit 61 causes the display 62 to display a predetermined image in accordance with a signal indicating an input operation of the user on the operation surface 11, which is output from the operation detecting unit 51. For example, a liquid crystal display may be used as the display 62; however, not limited thereto, another-type display may be used, such as an organic electro-luminescence (organic EL) display.

4. Specific Configuration of Input System

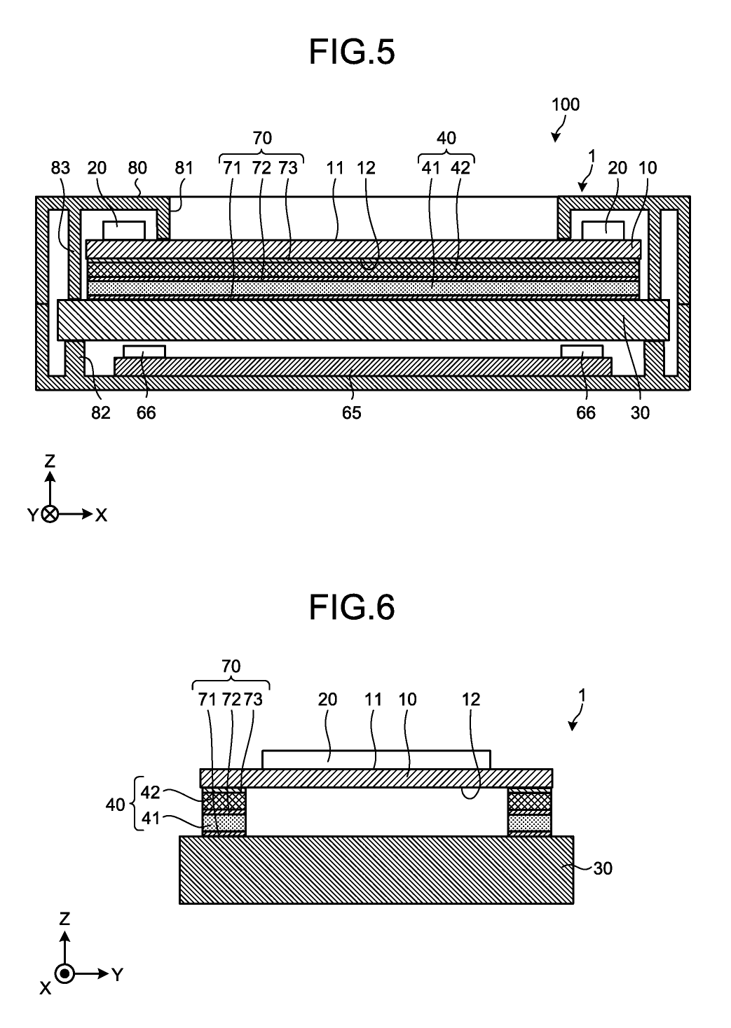

Next, the input system 100 including the input apparatus 1 will be more specifically explained with reference to FIGS. 4 to 6. FIG. 4 is a plan view illustrating the input system 100 according to the first embodiment. FIG. 5 is a cross-sectional view of FIG. 4 taken along a line V-V. FIG. 6 is a cross-sectional view of FIG. 4 taken along a line VI-VI.

The input system 100 includes the above-mentioned input apparatus 1, a control board 65 (see FIG. 5) on which the controller 50 is mounted, and a housing 80. In FIG. 6, for simplifying the illustration, illustration of the control board an the housing 80 is omitted.

On the control board 65, connection terminals 66 (see FIG. 5) are mounted in addition to the above-mentioned controller 50 etc. The connection terminals 66 are electrically connected to the vibrators 20 via wires (not illustrated).

The housing 80 is formed in a substantially rectangular parallelepiped shape, for example, and accommodates the input apparatus 1, the control board 65, and the like. In FIG. 4, the housing 80 is illustrated by using imaginary lines in order to clearly indicate the input apparatus 1 etc. accommodated in the housing 80.

An opening 81 is formed in the housing 80 that is formed in a substantially rectangular shape in a plan view. The operation panel 10 is arranged near the opening 81 of the housing 80, and a portion of the operation panel 10 that is exposed via the opening 81 become the operation surface 11.

As illustrated in FIG. 5, the housing 80 includes a mounting part 82 and a pressing part 83. The mounting part 82 protrudes upward from a bottom surface of the housing 80, and the supporting panel 30 is placed on the mounting part 82. The pressing part 83 protrudes downward from an upper surface of the housing 80. The pressing part 83 pushes the supporting panel 30 toward the mounting part 82. Thus, the input apparatus including the supporting panel 30 is stably held in the housing 80. The positions and shapes of the mounting part 82 and the pressing part 83, which are illustrated in FIG. 5, are merely examples, and not limited thereto.

As illustrated in FIG. 4, the operation panel 10 of the input apparatus 1 is a quadrilateral late, and specifically, is a rectangular-shaped plate having long sides 10a and short sides 10b. The supporting panel 30 is also a rectangular-shaped plate similarly to the operation panel 10.

Both of the operation panel 10 and the supporting panel 30 are made of glass having a comparatively high hardness. Thus, it is possible to improve the durability of the operation panel 10 and the supporting panel 30 against impact and heat from the outside, for example. The material of any of the operation panel 10 and the supporting panel 30 is not limited to glass, and may be made of another type material such as resin.

The vibrators 20 are attached to neighborhoods of the respective short sides 10b of the operation panel 10, for example. In other words, the vibrators 20 are attached to respective end portions of the operation panel 10 in a long side direction (X-axis direction). The vibrators 20 are oppositely arranged in outer-side regions of the operation surface 11, for example.

As illustrated in FIG. 4, the first and second holding parts 41 and 42 (first holding pa 41 is hidden by overlapped second holding part 42) are arranged in outer-side regions of the operation surface 11, for example. The first and second holding parts 41 and 42 are arranged at positions for holding neighborhoods of the long sides 10a of the operation panel 10. Preferably, each of the holding parts 40 including the first and second holding parts 41 and 42 is provided so as to have a length that is equal to or longer than that of an drive area to be vibrated by the vibrators 20, or correspond to a whole of the long sides 10a of the operation panel 10. Thus, it possible to efficiently generate a high-frequency vibration and a low-frequency vibration in the operation panel 10.

In other words, when vibration of the operation panel 10 causes deflection of the operation panel 10, generation of a high-frequency vibration etc. in the operation panel 10 is inhibited in some cases. Thus, in the present embodiment, the neighborhoods of the long sides 10a of the operation panel 10, which are easily deflected, are held by the first and second holding parts 41 and 42 to be able to reduce the deflection, so that it is possible to efficiently generate a high-frequency vibration and a low-frequency vibration in the operation panel 10.

In the above description, the first and second holding parts 41 and 42 are configured to hold the operation panel 10 over the whole length of the long sides 10a, this is merely one example and not limited thereto. In other words, for example, the first and second holding parts 41 and 42 may partially hold the neighborhoods of the long sides 10a of the operation panel 10; or may hold the operation panel 10 over the whole length of the short sides 10b, or may partially hold the neighborhoods of the short sides 10b.

As illustrated in FIGS. 5 and 6, both of the first and second holding parts 41 and 42 are formed separately from the operation panel 10. Hence, for example, when a design change in material, size, etc. occurs, it is sufficient that only a member is changed whose design is changed to be able to improve the versatility of the input apparatus 1.

As described above, the first and second holding parts 41 and 42 are formed separately from the operation panel 10, and thus theme members are glued and fixed to one another by using an adhesive part 70, for example. Each of the adhesive parts 70 includes a first adhesive part 71, a second adhesive part 72, and a third adhesive part 73.

For example, the first adhesive part 71 glues the supporting panel 30 and the first holding part 41, the second adhesive part 72 glues the first holding part 41 and the second holding part 42, and the third adhesive part 73 glues the second holding part 42 and the operation panel 10.

The first adhesive part 71 and the second adhesive part 72 are individually glued to the first holding part 41 having a comparatively low hardness, and thus the adhesive parts may have a comparatively low hardness, for example. As the first and second adhesive parts 71 and 72, for example, an adhesive tape (double sided tape) whose base material is polyolefin foam may be used, not limited thereto.

As described above, the hardness of the firs adhesive part 71 and the second adhesive part 72 is set to be comparatively low, similarly to the first holding part 41. Thus, for example, the operation panel 10 and the second holding part 42 that are vibrated at a low frequency are vibrated more largely, so that it is possible to more efficiently generate a low-frequency vibration in the operation panel 10.

The third adhesive part 73 is glued to the second holding part 42 having a comparatively high hardness, and thus the adhesive part may have a comparatively high hardness, for example. As the third adhesive part 73, an adhesive agent having a comparatively high hardness may be used, not limited thereto.

As described above, the hardness of the third adhesive part 73 is set to be comparatively high, similarly o the second holding part 42. Thus, the operation panel 10 is stiffly held (fixed) by the second holding parts 42 and the third adhesive parts so that it is possible to more efficiently generate a standing wave.

As described above, the input apparatus 1 according to the first embodiment includes the operation panel 10, the vibrators 20, and the holding parts 40. The operation panel 10 includes the operation surface 11. The vibrators 20 are attached to the operation panel 10, and vibrate the operation panel 10 in a plurality of modes having different vibration frequencies. The holding parts 40 hold the operation panel 10. Each of the holding parts 40 includes: the first holding part 41; and the second holding part 42 that has a higher hardness than the first holding part 41, and is arranged to be laminated on the first holding part 41. Thus, it is possible to efficiently generate, in the operation panel 10, vibration in a plurality of modes having different vibration frequencies.

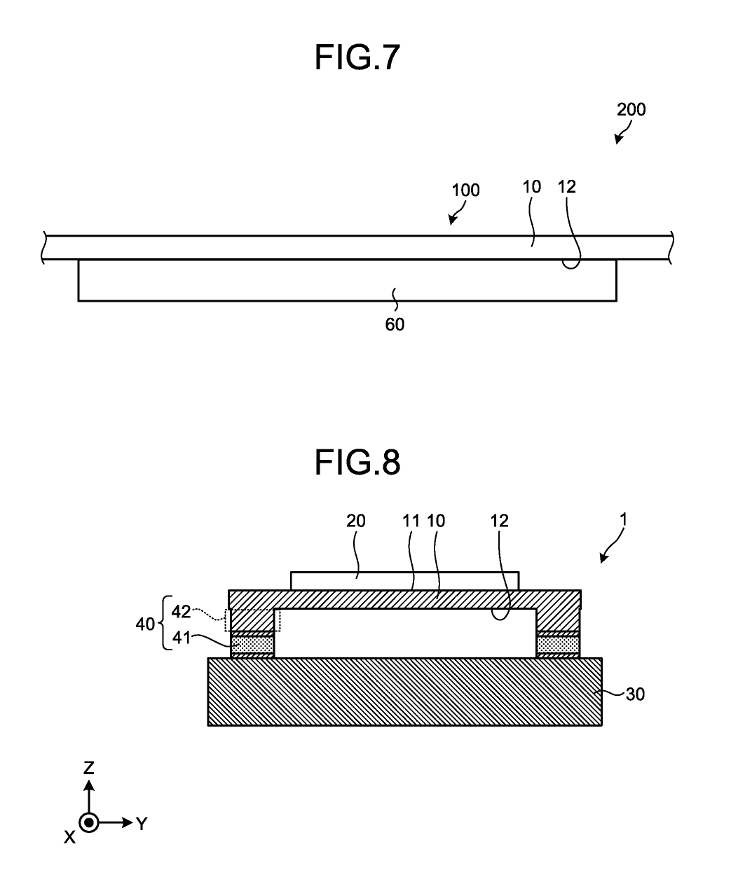

In the above-mentioned electronic-device system 200, the input system 100 and the display apparatus 60 are separately arranged (see FIG. 2), not limited thereto. In other words, as illustrated in FIG. 7, the electronic-device system 200 may have a configuration including touch panel in which the input system 100 and the display apparatus 60 are integrated with each other.

FIG. 7 is a diagram illustrating a relation between the input system 100 and the display apparatus 60 of the electronic-device system 200. As illustrated in FIG. 7, the display apparatus 60 is arranged on the reverse face 12 of the operation panel 10, and the user is able to see a screen (picture) that is displayed on the display apparatus 60 via the operation panel 10. In FIG. 7, illustration of the supporting panel 30 etc. is omitted.

5. Modification

Next, the input system 100 according to a modification will be explained with reference to FIG. 8. FIG. 8 is a side cross-sectional view illustrating the input apparatus 1 according to the modification. FIG. 8 is corresponding to FIG. 6, and illustration of the housing 80 etc. is omitted. Note that in the following, a part different from the first embodiment will be mainly described, and the common parts are represented with same symbols and the description is omitted appropriately.

In the above-mentioned first embodiment, the second holding parts 42 are formed separately from the operation panel 10, not limited thereto. In other words, as illustrated in FIG. 8, the second holding part 42 may be integrated with the operation panel 10. In FIG. 8, one of portions for holding the operation panel 10 is enclosed by using dashed lines, and the portion functions as the second holding part 42.

In this case, similarly to the case according to the first embodiment, the operation panel 10 is stiffly held by the second holding part 42, and thus a standing wave is easily generated in the operation panel 10, so that it is possible to efficiently generate a high-frequency vibration in the operation panel 10 as a result.

### Second Embodiment

6. Input Apparatus According to Second Embodiment

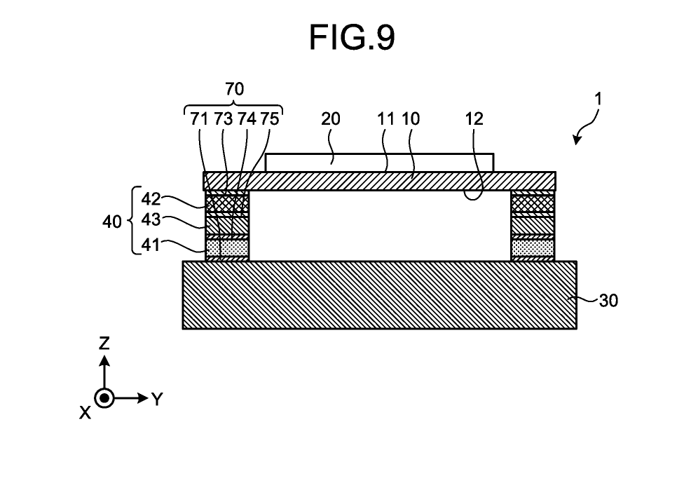

FIG. 9 is a side cross-sectional view illustrating the input apparatus 1 according to a second embodiment. FIG. 9 is corresponding to FIG. 6, and illustration of the housing 80 etc. is omitted. As illustrated in FIG. 9, each of the holding parts 40 according to the second embodiment is configured to further include third holding part 43.

For example, each of the third holding parts 43 is arranged to be laminated between the first holding part 41 and the second holding part 42. In other words, each of the holding parts 40 according to the second embodiment has a three-layer structure. The holding parts 40 may have a four-or more-layer structure.

Thus, for example, when a design change occurs for increasing the height of the operation panel 10 in the Z-axis direction, the design change is able to be performed without changing the first holding parts 41 and the second holding parts 42 by adding the third holding parts 43, so that it is possible to more improve the versatility of the input apparatus 1.

The third holding parts 43 are holding parts having a comparatively high hardness, and thus the hardness the third holding parts 43 may be equal to or more than the hardness of the second holding part 42, for example. The third holding parts 43 may be made of, but not limited thereto, glass and resin that includes glass among other things.

The third holding parts 43 are glued to the first holding parts 41 by using fourth adhesive parts 74. On the other hand, the third holding parts 43 are glued to the second holding parts 42 by using fifth adhesive parts 75.

The fourth adhesive parts 74 are glued to the first holding parts 41 having a comparatively low hardness, and thus, for example, adhesive parts having a comparatively low hardness may be used similarly to the second adhesive parts 72 according to the first embodiment. As the fourth adhesive parts 74, an adhesive tape (double sided tape) whose base material is polyolefin foam etc. may be used, not limited thereto.

Thus, for example, when vibrated at a low frequency, the operation panel 10 and the second and third holding parts 42 and 43 are vibrated more largely, so that it is possible to more efficiently generate a low-frequency vibration in the operation panel 10.

The fifth adhesive parts 75 are glued to the second holding parts 42 having a comparatively high hardness, and thus, for example, adhesive parts having a comparatively high hardness may be used. As the fifth adhesive parts 75, an adhesive agent having a comparatively high hardness may be used, not limited thereto.

As described above, in the second embodiment, the third holding parts 43 and the fifth adhesive party 75 having a comparatively high hardness are additionally laminated, and thus a high-frequency vibration generated in the operation panel 10 is indirectly transmitted to the first holding parts 41 via the third holding parts 43 and the fifth adhesive parts 75. Therefore, the high-frequency vibration of the operation panel 10 is not easily transmitted to the first holding parts 41, in other words, is not easily dissipated, so that it is possible to more efficiently generate a high-frequency vibration in the operation panel 10 as a result.

It the above description, the vibrators 20 are configured to be attached to the operation surface 11 of the operation panel 10, not limited thereto, the vibrators 20 may be attached to the reverse face 12 that is opposite to the operation surface 11 of the operation panel 10, for example.

In the above description, the case is exemplified in which the electronic-device system 200 is provided in the vehicle, not limited thereto, the electronic-device system 200 may be provided in another type apparatus such as a smartphone and a tablet terminal.

Additional advantages and modifications will readily occur to those skilled in the art. Therefore, the invention in its broader aspects is not limited to the specific details and representative embodiment shown and described herein. Accordingly, various modifications may be made without departing from the spirit or scope of the general inventive concept as defined by the appended claims and their equivalents.

What is claimed is:

1. An input apparatus comprising:
an operation panel that includes an operation surface;
a vibrator that is attached to the operation panel, and vibrates the operation panel in a plurality of modes having different vibration frequencies; and
a holding part that holds the operation panel, wherein
the holding part includes:
a first holding part; and
a second holding part that has a high r hardness than the first holding part, and is arranged to be laminated on the first holding part.

2. The input apparatus according to claim 1, wherein
the second holding part is separately formed from the operation panel.

3. The input apparatus according to claim 1, wherein
the second holding part is integrally formed with the operation panel.

4. The input apparatus according to claim 1, wherein
the second holding part is arranged to be laminated between the first holding part and the operation panel.

5. The input apparatus according to claim 2, wherein
the second holding part is arranged to be laminated between the first holding part and the operation panel.

6. The input apparatus according to claim 3, wherein
the second holding part is arranged to be laminated between the first holding part and the operation panel.

7. The input apparatus according to claim 1, wherein
the holding part further includes a third holding part that is arranged to be laminated between the first holding part and the second holding part.

8. The input apparatus according to claim 2, wherein
the holding part further includes a third holding part that is arranged to be laminated between the first holding part and the second holding part.

9. The input apparatus according to claim 3, wherein
the holding part further includes a third holding part that is arranged to be laminated between the first holding part and the second holding part.

10. The input apparatus according to claim 4, wherein
the holding part further includes a third holding part that is arranged to be laminated between the first holding part and the second holding part.

11. The input apparatus according to claim 5, wherein
the holding part further includes a third holding part that is arranged to be laminated between the first holding part and the second holding part.

12. The input apparatus according to claim 6, wherein
the holding part further includes a third holding par that is arranged to be laminated between the first holding part and the second holding part.

13. The input apparatus according to claim wherein
a hardness of the third holding part is set to be equal to or more than that of the second holding part.

14. The input apparatus according to claim 8, wherein
a hardness of the third holding part is set to be equal to or more than that of the second holding part.

15. The input apparatus according to claim 9, wherein
a hardness of the third holding part is set to be equal to or more than that of the second holding part.

16. The input apparatus according to claim 10, wherein
a hardness of the third holding part is set to be equal to or more than that of the second holding part.

17. The input apparatus according to claim 11, wherein
a hardness of the third holding part is set to be equal to or more than that of the second holding part.

18. The input apparatus according to claim 12, wherein
a hardness of the third holding part is set to be equal to or more than that of the second holding part.

19. An input system comprising:
an input apparatus including:
an operation panel that includes an operation surface;
a vibrator that is attached to the operation panel, and vibrates the operation panel; and
a holding part that holds the operation panel,
wherein
the holding part includes:
a first holding part; and
a second holding part that is arranged to be laminated on the first holding part, and has a higher hardness than the first holding part; and
a vibration controlling unit that controls and causes the vibrator to vibrate the operation panel in a plurality of modes having different vibration frequencies, based on an operation performed on the operation surface.

20. The input system according to claim 19, wherein
the vibration controlling unit controls, based on the operation performed on the operation surface, the vibrator so as to switch between a first vibration mode and a second vibration mode, the first vibration mode generating, in the operation panel, a vibration at a frequency within an ultrasonic band and the second vibration mode generating, in the operation panel, a vibration within a frequency band that is lower than the ultrasonic band.
